(19) United States
(12) Patent Application Publication
(10) Pub. No.: US 2025/0198316 A1
(43) Pub. Date: Jun. 19, 2025

(54) GASOLINE PARTICULATE FILTER

(71) Applicant: BASF CORPORATION, Florham Park, NJ (US)

(72) Inventors: Attilio SIANI, Hannover (DE); Chunyu CHEN, Shanghai (CN); Yehui WU, Shanghai (CN); Chenghao DENG, Shanghai (CN); Karifala DUMBUYA, Hannover (DE)

(21) Appl. No.: 18/845,753

(22) PCT Filed: Mar. 14, 2023
(86) PCT No.: PCT/CN2023/081336

§ 371 Date: Sep. 10, 2024

(30) Foreign Application Priority Data
Mar. 15, 2022 (WO) PCT/CN2022/080960

(51) Int. Cl. F01N 3/022; B01J 21/04; B01J 21/06; B01J 23/06; B01J 23/34; F01N 3/035; F01N 3/10

(52) U.S. Cl. CPC F01N 3/0222; B01J 21/04; B01J 21/066; B01J 23/06; B01J 23/34; F01N 3/035; F01N 3/101; F01N 2510/06

(57) ABSTRACT

A particulate filter, which comprises a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and a layer of inorganic particles loaded on surfaces of the porous walls in the inlet channels and/or outlet channels of the substrate, preferably in at least the inlet channels, wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

### FIELD OF THE INVENTION

The present invention relates to a particulate filter for treatment of exhaust stream from a gasoline engine, which comprises an inorganic powder particle coating. The present invention also relates to a gasoline engine exhaust treatment system comprising the particulate filter and a method for treating an exhaust stream from a gasoline engine.

### BACKGROUND OF THE INVENTION

Engine exhaust substantially consists of gaseous pollutants such as unburned hydrocarbons (HC), carbon monoxide (CO) and nitrogen oxides (NOx), and particulate matter (PM). For gasoline engines, three-way conversion catalysts (hereinafter interchangeably referred to as TWC catalyst or TWC) for gaseous pollutants and filters for particulate matter (PM) are well-known exhaust treatment means to ensure the exhaust emission to meet emission regulations.

In contrast to particulates generated by diesel lean burning engines, particulates generated by gasoline engines, such as gasoline direct injection engines, tend to be finer and in lesser quantities. This is due to different combustion conditions of a gasoline engine as compared to a diesel engine. Also, hydrocarbon components are different in the emissions of gasoline engines as compared to diesel engines. Particulate filters specific for gasoline engines have been developed for a few decades in order to effectively treating the engine exhaust from gasoline engines.

For example, WO 2018/024547A1 describes a catalyzed particulate filter comprising a TWC catalytic material permeating walls of a particulate filter. Coating a TWC catalytic material onto or within a filter may result in an impact of backpressure. A particular coating scheme was proposed in the patent application to avoid unduly increasing backpressure while providing full three-way conversion functionality. It is required that the catalyzed particulate filter has a coated porosity that is less than an uncoated porosity of the particulate filter.

GB 2560663B describes a particulate filter for use in an emission treatment system of a gasoline engine, which has an inlet side and an outlet side, wherein at least the inlet side is loaded with a synthetic ash having a D₉₀ of, for example, less than 5 μm and comprising one or more of aluminium oxide, zinc oxide, zinc carbonate, calcium oxide, calcium carbonate, cerium zirconium (mixed) oxide, zirconium oxide, cerium oxide and hydrated alumina. It is described that the synthetic ash is devoid of platinum group metal-containing catalytic material and the catalyst-poisoning materials sulphur oxides, phosphorus, magnesium, manganese, and lead.

It is known that gasoline particulate filter filtration performance will improve over the lifetime of the filter, primarily as a result of ash and soot accumulation on the walls of the inlet sides in the filter. Also, it was identified that particulate number of an emission generated during the cold start phase of a test cycle represents the primary portion of the total particles emitted during the test. Therefore, the particle filtration performance at the initial filtration phase, also called fresh filtration efficiency, is a main concern for developing gasoline particulate filters.

As particulate emissions from gasoline engines are being subject to more stringent regulations, such as Euro 6 and China 6, the vehicle manufacturers, i.e., original equipment manufacturers (OEMs) require gasoline particulate filters to have high fresh filtration efficiency.

Regeneration of a gasoline particulate filter becomes necessary when the pressure drop becomes unacceptable due to soot accumulation. Therefore, the regeneration performance of gasoline particulate filters is also an important concern.

There is a need to provide an improved particulate filter for treatment of exhaust stream from a gasoline engine, which could exhibit a higher fresh filtration efficiency under a low backpressure and/or desirable regeneration performance.

### SUMMARY OF THE INVENTION

The object of the present invention is to provide a particulate filter for treatment of an exhaust stream from gasoline engines, which exhibits a higher fresh filtration efficiency without suffering an unacceptable backpressure increase and/or desirable regeneration performance.

It has been surprisingly found that the object of the present invention was achieved by a particulate filter comprising a layer of inorganic powder particle in inlet channels and/or outlet channels of the filter.

Accordingly, in a first aspect, the present invention provides a particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels of the substrate,
   wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

In a second aspect, the present invention provides a method for producing a particulate filter, which includes
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
applying inorganic particles on surfaces of the porous walls in the inlet channels and/or outlet channels of the substrate, wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

In a third aspect, the present invention provides an exhaust treatment system comprising a particulate filter as described in the first aspect or a particulate filter obtainable or obtained from the method as described in the second aspect, which is located downstream of a gasoline engine.

In a fourth aspect, the present invention provides a method for treating an exhaust stream from a gasoline engine, which includes contacting the exhaust stream with a particulate filter as described in the first aspect or an exhaust treatment system as described in the third aspect.

It has been found that the particulate filter according to the present invention for treatment of exhaust stream from a gasoline engine, also referred to as gasoline particulate filter herein, could provide an improved fresh filtration efficiency compared with prior art counterparts, while no significant backpressure increase was observed. It has also been found that the gasoline particulate filter exhibit significantly improved regeneration performance.

### BRIEF DESCRIPTION OF THE DRAWINGS

FIG. 1 illustrates an external view of a wall-flow substrate having an inlet end and an outlet end.

FIG. 2 illustrates a longitudinal sectional view of an exemplary wall-flow substrate having a plurality of porous walls extending longitudinally from an inlet end to an outlet end of the substrate.

FIG. 3A depicts THC conversions for the particulate filters of Inventive Example 2 and Comparative Example 3.

FIG. 3B depicts CO conversions for the particulate filters of Inventive Example 2 and Comparative Example 3.

FIG. 3C depicts NOx conversions for the particulate filters of Inventive Example 2 and Comparative Example 3.

FIG. 4A depicts inlet temperature (T-in) and bed temperature (T-bed) for the particulate filter of Comparative Example 4 during measurement of soot burning activity.

FIG. 4B depicts inlet temperature (T-in) and bed temperature (T-bed) for the particulate filter of Inventive Example 4 during measurement of soot burning activity.

FIG. 5A depicts O₂ concentrations for both inlet (O₂-in) and outlet (O₂-out) of the particulate filter of Comparative Example 4 during measurement of soot burning activity.

FIG. 5B depicts O₂ concentration for both inlet (O₂-in) and outlet (O₂-out) of the particulate filter of Inventive Example 4 during measurement of soot burning activity.

### DETAILED DESCRIPTION OF THE INVENTION

The present invention will be described in detail hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or cognates may be embraced within “comprises” or cognates.

Herein, the term “layer”, for example within the context of the layer of inorganic particles, is intended to mean a thin gas-peameable coating of materials carried on blank or pre-coated walls of a substrate. The layer may be in form of packed particles on walls of the substrate with gaps therebetween allowing for gas to permeate through.

The term “D₉₀” has its usual meaning of referring to the point where the cumulative volume from the small-particle-diameter side reaches 90% in the cumulative particle size distribution. D₉₀ is the value determined by measuring the particle size distribution. The particle size distribution is measured by using a laser diffraction particle size distribution analyzer.

The terms for platinum group metal (PGM) components, such as “palladium component”, “platinum component” and “rhodium component” are intended to describe the presence of respective platinum group metals in any possible valence state, which may be for example metal or metal oxide as the catalytically active form, or may be for example metal compound, complex or the like which, upon calcination or use of the catalyst, decomposes or otherwise converts to the catalytically active form.

The term “support” refers to a material in form of particles, for receiving and carrying one or more PGM components, and optionally one or more other components such as stabilizers, promoters and binders.

Herein, any reference to an amount of loading in the unit of g/ft³ or g/in³ is intended to mean the weight of the specified component, coat or layer per unit volume of the substrate on which they are carried.

According to the first aspect of the present invention, a particulate filter is provided, which comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels of the substrate,
   wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

The substrate as used herein refers to a structure suitable for withstanding conditions encountered in an exhaust stream from combustion engines, which can function as a particulate filter by itself, and can also carry functional materials, for example a filtration-improving layer such as a layer of inorganic particles as described herein, and optionally any other layer.

The substrate comprises a plurality of porous walls extending longitudinally to form a plurality of parallel channels extending from an inlet end to an outlet end, wherein a quantity of the channels being inlet channels that are open at the inlet end and closed at the outlet end, and a quantity of channels different from the inlet channels are outlet channels that are closed at the inlet end and open at the outlet end. The configuration of the substrate, also referred to as wall-flow substrate, requires the engine exhaust in the inlet channels flows through the porous walls of the substrate into the outlet channels to reach the outlet end.

Generally, the substrate may exhibit a honeycomb structure with alternate channels being blocked with a plug at opposite ends.

The porous walls of the substrate are generally made from ceramic materials or metal materials. Suitable ceramic materials useful for constructing the substrate may include any suitable refractory material, e.g., cordierite, mullite, cordierite-alumina, silicon carbide, silicon nitride, zirconia, mullite, spodumene, alumina-silica-magnesia, zirconium silicate, magnesium silicates, sillimanite, petalite, alumina, aluminium titanate and aluminosilicates. Typically, the porous walls of the substrate are made from cordierite or silicon carbide.

Suitable metallic materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15% by weight of the alloy, for example 10 to 25% by weight of chromium, 3 to 8% by weight of aluminium, and up to 20% by weight of nickel. The alloys may also contain small or trace amounts of one or more metals such as manganese, copper, vanadium, titanium and the like. The surface of the metallic substrate may be oxidized at high temperature, e.g., 1000° C. or higher, to form an oxide layer on the surface of the substrate, improving the corrosion resistance of the alloy and facilitating adhesion of the washcoat layer to the metal surface.

The channels at the closed ends are blocked with plugs of a sealant material. Any suitable sealant materials may be used without being limited.

The channels of the substrate can be of any suitable cross-sectional shape and size, such as circular, oval, triangular, rectangular, square, hexagonal, trapezoidal or other polygonal shapes. The substrate may have up to 700 channels (i.e. cells) per square inch of cross section. For example, the substrate may have 100 to 500 cells per square inch (“cpsi”), typically 200 to 400 cpsi. The walls of the substrate may have various thicknesses, with a typical range of 2 mils to 0.1 inches. Preferably, the substrate has a number of inlet channels that is equal to the number of outlet channels, and the channels are evenly distributed throughout the substrate.

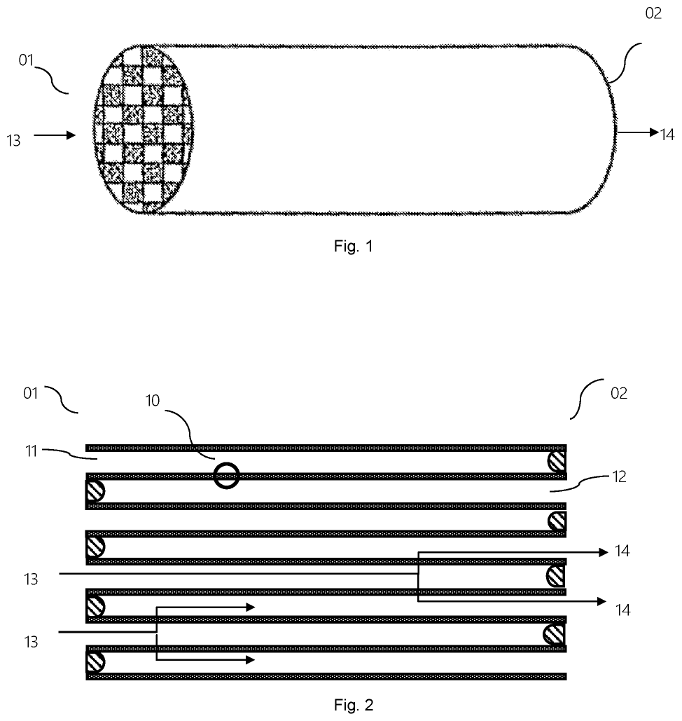

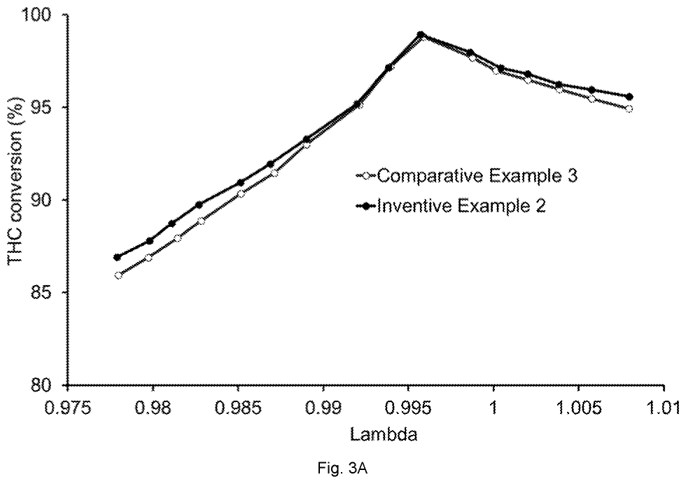

FIGS. 1 and 2 illustrate a typical wall-flow substrate comprising a plurality of inlet and outlet channels.

FIG. 1 schematically depicts an external view of the wall-flow substrate having an inlet end (01) from which exhaust stream (13) enters the substrate and an outlet end (02) from which the treated exhaust exits. Alternate channels are blocked with plugs to form a checkerboard pattern at the inlet end (01) as shown and an opposing checkerboard pattern at the outlet end (02) which is not shown.

FIG. 2 schematically depicts a longitudinal sectional view of the wall-flow substrate, comprising a first plurality of channels (11) which are open at the inlet end (01) and closed at the outlet end (02), and a second plurality of channels (12) which are open at the outlet end (02) and closed at the inlet end (01). The channels are preferably parallel to each other to provide a constant wall thickness between the channels. The exhaust stream entering the first plurality of channels from the inlet end cannot leave the substrate without diffusing through the porous walls (10) into the second plurality of channels.

The particulate filter according to the present invention may comprise the layer of inorganic particles loaded on surfaces of the porous walls in the inlet channels and/or outlet channels of the substrate. In other words, the layer of inorganic particles may be loaded on the porous walls in the inlet channels alone, in the outlet channels alone or in both inlet channels and outlet channels. Particularly, the layer of inorganic particles may be loaded on the porous walls in the inlet channels alone or in both inlet channels and outlet channels, more preferably in the inlet channels alone.

It will be appreciated that the layer of inorganic particles is intended to be loaded onto surfaces of the porous walls in the inlet and/or outlet channels, which is also referred to as “on-wall” coat, while a minor amount of inorganic particles may infiltrate into the pores within the porous walls.

The inorganic particles comprise the first inorganic component in an amount of 30 to 97%, particularly 50 to 97%, based on the total weight of the inorganic particles. For example, the inorganic particles comprise the first inorganic component in an amount of 30%, 50%, 51%, 52%, 53%, 54%, 55%, 56%, 57%, 58%, 59%, 60%, 65%, 70%, 75%, 80%, 85%, 86%, 87%, 88%, 89%, 90%, 95%, 96% or 97%. Particularly, the inorganic particles comprise the first inorganic component in an amount of 85 to 97%, 88 to 96% or 90 to 96% based on the total weight of the inorganic particles. Alternatively, the inorganic particles comprise the first inorganic component in an amount of 30 to 60%, 50 to 60% or 54 to 58%, based on the total weight of the inorganic particles.

The inorganic particles comprise the second inorganic component in an amount of 3 to 70%, particularly 3 to 50%, based on the total weight of the inorganic particles. For example, the inorganic particles comprise the second inorganic component in an amount of 3%, 4%, 5%, 10%, 11%, 12%, 13%, 14%, 15%, 20%, 25%, 30%, 35%, 40%, 41%, 42%, 43%, 44%, 45%, 46%, 47%, 48%, 49%, 50% or 70%. Particularly, the inorganic particles comprise the second inorganic component in an amount of 3 to 15%, 4 to 12% or 4 to 10%, based on the total weight of the inorganic particles. Alternatively, the inorganic particles comprise the first inorganic component in an amount of 40 to 70%, 40 to 50% or 42 to 46%, based on the total weight of the inorganic particles.

In some embodiments, the inorganic particles comprise the first inorganic component in an amount of 85 to 97% and the second inorganic component in an amount of 3 to 15%, based on the total weight of the inorganic particles. Further, the inorganic particles may comprise the first inorganic component in an amount of 88 to 96% and the second inorganic component in an amount of 4 to 12%, based on the total weight of the inorganic particles. Particularly, the inorganic particles comprise the first inorganic component in an amount of 90 to 96% and the second inorganic component in an amount of 4 to 10%, based on the total weight of the inorganic particles.

In some other embodiments, the inorganic particles comprise the first inorganic component in an amount of 30 to 60% and the second inorganic component in an amount of 40 to 70%, based on the total weight of the inorganic particles. Further, the inorganic particles may comprise the first inorganic component in an amount of 50 to 60% and the second inorganic component in an amount of 40 to 50%, based on the total weight of the inorganic particles. Particularly, the inorganic particles may comprise the first inorganic component in an amount of 54 to 58% and the second inorganic component in an amount of 42 to 46%, based on the total weight of the inorganic particles.

The amount of the first inorganic component refers to a total amount of each component, when there is more than one species present as the first inorganic component.

The amount of the second inorganic component refers to a total amount of manganese oxides calculated as MnO₂, when manganese oxides having different oxidation states are present as the second component.

The first inorganic component is preferably one or more selected from alumina, zirconia, ceria, silica, titania, zinc oxide and rare earth metal oxide other than ceria. More preferably, the first inorganic component is one or more selected from alumina, zirconia and zinc oxide. Particularly the first inorganic component comprises or is alumina.

The manganese oxide as the second inorganic component may be selected from oxides of manganese in any state, for example one or more of MnO₂, MnO, Mn₂O, Mn₂O₃, Mn₃O₄ and Mn₂O₇. Preferably, the second inorganic component comprises or is MnO₂.

It is to be understood that each of the first and second inorganic components may be a physical mixture of two or more species as mentioned above or a composite of two or more species, when there is more than one species present as the first or second inorganic component.

The first inorganic component and the second inorganic component may be comprised in form of a physical mixture of respective particles, i.e., a mixture of particles of the first inorganic component and particles of the second inorganic component.

Alternatively, the first inorganic component and the second inorganic component may be comprised in form of particles of a composite thereof. For example, the first inorganic component may be doped with and/or supporting the second inorganic component. In other words, species of the first inorganic component and species of the second inorganic component will be found in a single particle.

The inorganic particles may optionally comprise a PGM component, such as palladium component and/or platinum component. The PGM component, if present, may be supported on or separate from the first component and/or second component.

Herein, the layer of inorganic particles loaded on the porous walls in the inlet and/or outlet channels of the substrate particularly refers to a layer exhibiting minor or no, preferably no TWC activity, although it may exhibit a certain catalytic activity if one or more PGM components are comprised in the inorganic particles.

In some embodiments, the inorganic particles do not comprise a PGM component, preferably consists of the first inorganic component and and the second inorganic component.

The particulate filter may comprise the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).

The layer of inorganic particles may be applied onto the surfaces of the porous walls of the channels of the substrate by any known processes, such as dry coating process and washcoating process.

The dry coating process is well-known and generally carried out by blowing the inorganic particles or suitable precursors thereof in particulate form by means of a carrier gas stream into channels of a substrate from the open ends, and calcining the coated substrate. By this process, no liquid carrier will be used. The inorganic particles are typically distributed on the surfaces of the porous walls of the channels in form of a particle bed.

In some embodiments, the inorganic particles or suitable precursors thereof may be blown into the inlet channels from the open ends toward the closed ends of the channels. The formed particle beds in the inlet channels may be located on the porous walls of the inlet channels, and also against the plog blocking the channels. As described hereinabove, the particle beds, i.e., the layer of inorganic particles are gas-peamable, which can contribute to trapping particulate matter (PM) of the exhaust stream and allow gaseous pollutants of the exhaust stream to permeate therethrough.

The layer of inorganic particles in form of particle beds may extend along the porous walls of the channels where the inorganic particles are loaded. It will be appreciated that the particle beds may extend along the entire length of the porous walls of the channels, or along only a part of the length of the porous walls of the channels.

The washcoating process is also well-known and generally carried out by coating a slurry comprising the inorganic particles or suitable precursors thereof and optional auxiliaries in a liquid solvent (e.g. water) into channels of a substrate from the open ends, drying and calcining the coated substrate. The layer of inorganic particles applied by washcoating may be in the form of a porous coating, which may extend along the porous walls of the channels where the inorganic particles are loaded. Also, the porous coating may extend along the entire length of the porous walls of the channels, or along only a part of the length of the porous walls of the channels.

The particulate filter according to the present invention may further comprise a TWC coat in at least a portion of the inlet channels and/or outlet channels of the substrate. Particularly, the TWC coat is present in both inlet channels and outlet channels of the substrate.

The TWC coat is typically in form of a washcoat comprising a TWC composition, also referred to as “in-wall” coat.

It will be appreciated that the TWC coat is intended to be loaded in pores of the porous walls of the channels, while an appreciable amount of TWC composition may also be found on the surfaces of the porous walls in the coated channels.

There is no particular restriction to the TWC composition useful for the TWC coat comprised in the particulate filter. Typically, the TWC compostions comprises platinum group metal components as catalytically active species, e.g., rhodium component and one or both of platinum component and palladium component, which are supported on support particles. Useful materials as the support may be refractory metal oxides, oxygen storage components and any combinations thereof.

Examples of the refractory metal oxide may include, but are not limited to alumina, lanthana doped alumina, baria doped alumina, ceria doped alumina, zirconia doped alumina, ceria-zirconia doped alumina, lanthana-zirconia doped alumina, baria-lanthana doped alumina, baria-ceria doped alumina, baria-zirconia doped alumina, baria-lanthana-neodymia doped alumina, lanthana-ceria doped alumina, and any combinations thereof.

Examples of the oxygen storage component (OSC) may include, but are not limited to reducible rare earth metal oxides, such as ceria. The oxygen storage component may also comprise one or more of lanthana, praseodymia, neodymia, europia, samaria, ytterbia, yttria, zirconia and hafnia to constitute a composite oxide with ceria. Particularly, the oxygen storage component is selected from ceria-zirconia composite oxide and stabilized ceria-zirconia composite oxide.

The particulate filter according to the present invention may comprise the TWC coat at at a loading of 0.1 to 5.0 g/in³ (i.e., about 6.1 to 305.1 g/L), or 0.5 to 3.0 g/in³ (i.e., about 30.5 to 183.1 g/L), or 0.8 to 2 g/in³ (i.e., about 49 to 122 g/L).

The TWC coat may comprise the PGM components at a total loading of 1.0 to 50.0 g/ft³ (i.e., about 0.04 to 1.8 g/L), or 5.0 to 20.0 g/ft³ (i.e., about 0.18 to 0.71 g/L), calculated as respective PGM element.

The TWC coat may be applied onto the substrate by any known processes, typically by a washcoating process. The washcoating process is generally carried out by coating a slurry comprising TWC catalyst particles of supported PGM components and optionally auxiliaries in a solvent (e.g. water), drying and calcining the coated substrate.

The TWC coat, when present, will be applied onto the substrate before loading the layer of inorganic particles as described hereinabove.

In some illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in at least the inlet channels of the substrate, and
optionally a TWC coat, preferably a washcoat comprising a TWC composition,
   wherein the inorganic particles comprise a first inorganic component selected from alumina, zirconia, ceria, silica, titania, zinc oxide, rare earth metal oxide other than ceria or any combinations thereof, and a manganese oxide as a second inorganic component, and
   wherein the second inorganic component is comprised in an amount of 3 to 15% or 40 to 70%, based on the total weight of the inorganic particles.

In further illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in at least the inlet channels of the substrate, and
optionally a washcoat comprising a TWC composition,
   wherein the inorganic particles comprise a first inorganic component selected from alumina, zirconia, zinc oxide or any combinations thereof, and a manganese oxide as a second inorganic component, and
   wherein the second inorganic component is comprised in an amount of 3 to 15% or 40 to 70%, based on the total weight of the inorganic particles.

In some other illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in at least the inlet channels of the substrate, and
optionally a washcoat comprising a TWC composition,
   wherein the inorganic particles comprise a first inorganic component selected from alumina, zirconia, zinc oxide or any combinations thereof, and a manganese oxide as a second inorganic component, and
   wherein the second inorganic component is comprised in an amount of 4 to 12% or 40 to 50%, based on the total weight of the inorganic particles.

In those illustrative embodiments as described above, it is preferred that the layer of inorganic particles does not comprise a PGM component.

The particulate filter may be housed within a shell having an inlet and an outlet for exhaust stream, that may be operatively associated and in fluid communication with other parts of an exhaust treatment system of an engine.

According to the second aspect of the present invention, a method for producing a particulate filter is provided, which includes,
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
applying inorganic particles on surfaces of the porous walls in the inlet channels and/or outlet channels of the substrate, wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

The inorganic particles may be applied on the surfaces of the porous walls by dry coating process or washcoating as described hereinabove in the first aspect, preferably a dry coating process.

In some embodiments, the method for producing a particulate filter further includes applying a TWC coat in the porous walls in at least a portion of the inlet and/or outlet channels of the substrate before applying the inorganic particles on surfaces of the porous walls. The TWC coat may be applied by a washcoating process as described hereinabove.

Any general description and preferences described hereinabove for the inorganic particles and TWC coat in the first aspect are applicable here by reference.

According to the third aspect, an exhaust treatment system is provided, which comprises a particulate filter as described in the first aspect or a particulate filter obtainable or obtained from the method as described in the second aspect, and is located downstream of a gasoline engine.

According to the fourth aspect, a method for treating an exhaust stream from a gasoline engine is provided, which includes contacting the exhaust stream with a particulate filter as described in the first aspect or an exhaust treatment system as described in the third aspect.

### Embodiments

Various embodiments are listed below. It will be understood that the embodiments listed below may be combined with all aspects and other embodiments in accordance with the scope of the invention.
1. A particulate filter, which comprises
   a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
   a layer of inorganic particles loaded on surfaces of the porous walls in the inlet channels and/or outlet channels of the substrate, preferably in at least the inlet channels,
   wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.
2. The particulate filter according to Embodiment 1, wherein the first inorganic component is one or more selected from alumina, zirconia, ceria, silica, titania, zinc oxide and rare earth metal oxide other than ceria.
3. The particulate filter according to Embodiment 2, wherein the first inorganic component is one or more selected from alumina, zirconia and zinc oxide.
4. The particulate filter according to Embodiment 3, wherein the first inorganic component comprises or is alumina.
5. The particulate filter according to any of preceding Embodiments, wherein the layer of inorganic particles exhibits no three-way conversion catalytic activity.
6. The particulate filter according to any of preceding Embodiments, wherein the layer of inorganic particles does not comprise a PGM component.
7. The particulate filter according to any of preceding Embodiments, which further comprises a three-way conversion catalyst (TWC) coat, preferably a washcoat comprising a TWC composition.
8. The particulate filter according to Embodiment 7, wherein the three-way conversion catalyst coat is in at least a portion of the inlet channels and/or outlet channels of the substrate.
9. The particulate filter according to any of preceding Embodiments, which comprises the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).
10. The particulate filter according to any of preceding Embodiments, which is a gasoline particulate filter.
11. The particulate filter according to any of preceding Embodiments, wherein the inorganic particles comprise the second inorganic component in an amount of 3 to 70% or 3 to 50%, based on the total weight of the inorganic particles.
12. The particulate filter according to Embodiment 11, wherein the inorganic particles comprise the second inorganic component in an amount of 3 to 15%, 4 to 12% or 4 to 10%, based on the total weight of the inorganic particles.
13. The particulate filter according to Embodiment 11, wherein the inorganic particles comprise the second inorganic component in an amount of 40 to 70%, 40 to 50% or 42 to 46%, based on the total weight of the inorganic particles.
14. A method for producing a particulate filter as defined in any of preceding Embodiments, which includes
   providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
   applying inorganic particles on surfaces of the porous walls in the inlet channels and/or outlet channels of the substrate, wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.
15. The method according to Embodiment 14, wherein the inorganic particles are applied by a dry coating process or washcoating process, preferably by a dry coating process.
16. The method according to Embodiment 15, wherein the inorganic particles are applied by using the inorganic particles or precursors thereof.
17. An exhaust treatment system, which comprises a particulate filter according to any of Embodiments 1 to 13 or a particulate filter obtainable or obtained from the method according to any of Embodiments 14 to 16, and is located downstream of a gasoline engine.
18. A method for treating an exhaust stream from a gasoline engine, which includes contacting the exhaust stream with a particulate filter as defined in any of Embodiments 1 to 13 or an exhaust treatment system as defined in Embodiment 17.

Aspects of the present invention are more fully illustrated by the following Examples, which are set forth to illustrate certain aspects of the present invention and are not to be construed as limiting thereof.

### EXAMPLES

### I. Preparation of Particulate Filters

### Reference Example 1

A gasoline particulate filter cordierite substrate was used as a reference filter (blank filter), which has a size of 143.8 mm (D)×123.2 mm (L), a volume of 2.0 L (about 122.1 in³), a cell density of 300 cells per square inch (cpsi), a wall thickness of 8 mils and a porosity of 65% as determined by a mercury intrusion measurement.

### Comparative Example 1

A particulate filter having a TWC coat was prepared from a filter substrate which is the same as the blank filter of Reference Example 1, by applying a TWC washcoat into both inlet channels and outlet channels of the blank filter.

30.22 g of a 9.68 wt % aqueous rhodium nitrate solution was impregnated onto 255 g of a high surface area gamma alumina powder in a planetary mixer (P-mixer) to form a wet powder while achieving incipient wetness. 14.27 g of a 20.5 wt % aqueous palladium nitrate solution was impregnated onto 711 g of a ceria/zirconia (40% ceria) composite powder in planetary mixer (P-mixer) to form a wet powder while achieving incipient wetness. An aqueous slurry was formed by mixing above two wet powders with 1280 g of D.I. water, to which 78 g of barium hydroxide octahydrate and 66 g of a 21.5 wt % aqueous zirconium nitrate solution were added. The pH of the slurry was adjusted to 3.6 with nitric acid. The slurry was milled to a particle size D₉₀ of 4.5 μm, and then coated into the inlet channels of the blank filter with 50% of the washcoat loading and into the outlet channels of the blank filter with the rest 50% of the washcoat loading. The coated substrate was dried at a temperature of 150° C. for 1 hour and then calcined at a temperature of 550° C. for 1 h.

The in-wall TWC coat was obtained with a washcoat loading of about 0.99 g/in³ (60 g/L) and a total PGM loading of about 10.0 g/ft³ (0.35 g/L) with a Pd/Rh ratio of 5/5.

### Comparative Example 2

A particulate filter having a TWC coat and a layer of inorganic particles of Al₂O₃ was prepared.

A particulate filter having a TWC coat was first prepared by repeating the same process as described in Comparative Example 1. Then, a high surface area gamma alumina powder was mixed with a carrier gas and blown into the inlet channels of the filter at a flow rate of 600 m³/h at room temperature. The alumina powder has been pretreated by dry milling to a particle size D₉₀ of 4.8 μm as measured by a Sympatec HELOS laser diffraction particle size analyzer, with a specific surface area (BET model, 77K nitrogen adsorption measurement) of 61 m²/g after calcination at 1100° C. in air for 4 hours. After coating, the filter with a layer of inorganic particles in the inlet channels was calcined at a temperature of 550° C. for 1 hour. The loading of the alumina particles in the functional material layer was 3 g/L (0.05 g/in³).

### Comparative Example 3

A particulate filter having a TWC coat and a layer of inorganic particles was prepared by repeating the same process as described in Comparative Example 2 and then aged in an atmosphere of 10% steam in air at 1000° C. for 4 hours.

### Comparative Example 4

A particulate filter having a layer of inorganic particles of Al₂O₃ was prepared.

A particulate filter having a layer of inorganic particles was prepared from a filter substrate, which has a size of 132.1 mm (D)×120 mm (L), a volume of 1.64 L (about 100.4 in³), a cell density of 200 cells per square inch (cpsi), a wall thickness of 8.5 mils and a porosity of 55% as determined by a mercury intrusion measurement.

A high surface area gamma alumina powder was mixed with a carrier gas and blown into the inlet channels of the filter at a flow rate of 600 m³/h at room temperature. The alumina powder has been pretreated by dry milling to a particle size D₉₀ of 4.8 μm as measured by a Sympatec HELOS laser diffraction particle size analyzer, with a specific surface area (BET model, 77K nitrogen adsorption measurement) of 61 m²/g after calcination at 1100° C. in air for 4 hours.

After coating, the filter with a layer of inorganic particles in the inlet channels was calcined at a temperature of 550° C. for 1 hour. The loading of the alumina particles in the layer of inorganic particles was 3.75 g/L (about 0.06 g/in³).

### Comparative Example 5

A particulate filter having a TWC coat and a layer of inorganic particles of Al₂O₃ and MnO₂ (50:1) was prepared.

A particulate filter having a TWC coat was first prepared by repeating the same process as described in Comparative Example 1. Then, a mixture of a high surface area gamma alumina powder and a manganese dioxide (MnO₂) powder at a weight ratio of 50:1 was mixed with a carrier gas and blown into the inlet channels of the filter at a flow rate of 600 m³/h at room temperature. The alumina powder has been pretreated by dry milling to a particle size D₉₀ of 4.8 μm as measured by a Sympatec HELOS laser diffraction particle size analyzer, with a specific surface area (BET model, 77K nitrogen adsorption measurement) of 61 m²/g after calcination at 1100° C. in air for 4 hours. The MnO₂ powder has been pretreated by dry milling to a particle size D₉₀ of 6.8 μm.

After coating, the filter with a layer of inorganic particles in the inlet channels was calcined at a temperature of 550° C. for 1 hour. The loading of the alumina in the layer of inorganic particles was 3 g/L (about 0.05 g/in³) and the loading of MnO₂ was 0.06 g/L (about 0.001 g/in³).

### Inventive Example 1

A particulate filter having a TWC coat and a layer of inorganic particles of Al₂O₃ and MnO₂ (20:1) was prepared by repeating the same process as described in Comparative Example 5, except that the weight ratio of the alumina powder to manganese dioxide powder is 20:1. The loading of the alumina in the layer of inorganic particles was 3 g/L (about 0.05 g/in³) and the loading of MnO₂ was 0.15 g/L (about 0.0025 g/in³).

### Inventive Example 2

A particulate filter having a TWC coat and a layer of inorganic particles was prepared by repeating the same process as described in Inventive Example 1 and then aged in an atmosphere of 10% steam in air at 1000° C. for 4 hours.

### Inventive Example 3

A particulate filter having a TWC coat and a layer of inorganic particles of Al₂O₃ and MnO₂ (10:1) was prepared by repeating the same process as described in Comparative Example 5, except that the weight ratio of the alumina powder to manganese dioxide powder is 10:1. The loading of the alumina in the layer of inorganic particles was 3 g/L (about 0.05 g/in³) and the loading of MnO₂ was 0.3 g/L (about 0.005 g/in³).

### Inventive Example 4

A particulate filter having a layer of inorganic particles of Al₂O₃ and MnO₂ (5:4) was prepared.

A particulate filter having a layer of inorganic particles was prepared from a filter substrate, which has a size of 132.1 mm (D)×120 mm (L), a volume of 1.64 L (about 100.4 in³), a cell density of 200 cells per square inch (cpsi), a wall thickness of 8.5 mils and a porosity of 55% as determined by a mercury intrusion measurement.

A mixture of a high surface area gamma alumina powder and a manganese dioxide (MnO₂) powder at a weight ratio of 5:4 was mixed with a carrier gas and blown into the inlet channels of the filter at a flow rate of 600 m³/h at room temperature. The alumina powder has been pretreated by dry milling to a particle size D₉₀ of 4.8 μm as measured by a Sympatec HELOS laser diffraction particle size analyzer, with a specific surface area (BET model, 77K nitrogen adsorption measurement) of 61 m²/g after calcination at 1100° C. in air for 4 hours. The MnO₂ powder has been pretreated by dry milling to a particle size D₉₀ of 6.8 μm.

After coating, the filter with a layer of inorganic particles in the inlet channels was calcined at a temperature of 550° C. for 1 hour. The loading of the alumina in the layer of inorganic particles was 3.75 g/L (about 0.06 g/in³) and the loading of MnO₂ was 3 g/L (about 0.05 g/in³).

### II. Filtration Performance

### II.1 Backpressure

The particulate filters were investigated for backpressure, which was measured by a SuperFlow SF-1020 Flowbench under a cold air flow at 600 m³/h.

### II.2 Filtration Efficiency

The filtration efficiencies of the particulate filters at fresh state (0 km, or out-of-box state) were measured, in accordance with the standard procedure defined in “BS EN ISO 29463-5:2018-Part 5: Test method for filter elements”, on a stationary air filter performance testing bench with a cold air flow at 600 m³/h, using aerosol di(2-ethyl-hexyl) sebacate as particles. Particle number (PN) of particles ranging between 0.10 and 0.15 μm was recorded by a PN counter for both upstream and downstream of the filter being tested. The fresh filtration efficiency (FFE) was calculated in accordance with the equation

$$FFE = ( 1 - \frac{P {N}_{( d o w n s t r e a m )}}{P {N}_{( upstream}} ) \times 100 \% .$$

The test results are summarized in the table below.

| | | Layer of | | | |
|---|---|---|---|---|---|
| | TWC | Inorganic | 1^{st} and 2^{nd} | Backpressure | FFE |
| Example | Coat | Particles | Components | (mbar) | (%) |
| Reference | no | no | / | 23 | 73 |
| Example 1 | | | | | |
| Comparative | yes | no | / | 25 | 72 |
| Example 1 | | | | | |
| Comparative | yes | yes | Al₂O₃ | 30 | 85 |
| Example 2 | | | | | |
| Comparative | yes | yes | 98.04% Al₂O₃, | 30 | 85 |
| Example 5 | | | 1.96% MnO₂ | | |
| Inventive | yes | yes | 95.24% Al₂O₃, | 30 | 87 |
| Example 1 | | | 4.76% MnO₂ | | |
| Inventive | yes | yes | 90.91% Al₂O₃, | 29 | 87 |
| Example 3 | | | 9.09% MnO₂ | | |

It can be seen from the comparison between Comparative Example 1 and Reference Example 1 that the particulate filter with a TWC coat has a lower fresh filtration efficiency (FFE) than the blank filter, although a comparable low backpressure was maintained, that may be because the TWC components permeate into the porous walls of the substrate of the particulate filter.

The fresh filtration efficiency may be improved by applying a layer of inorganic particles onto the porous walls of the inlet channels of the substrate of the particulate filter, as shown in Comparative Example 2, with an acceptable increase of backpressure.

It has been surprisingly found that the fresh filtration efficiency can be further improved by applying more than 2% MnO₂ particles together with Al₂O₃ onto the porous walls of the substrate of the particulate filter. The particulate filters of Inventive Examples 1 and 3 exhibit 2% higher fresh filtration efficiency (FFE) than the particulate filters of Comparative Example 2, while the particulate filters of Comparative Example 5 did not. The increase of FFE of 2% in accordance with the test method using 0.10 and 0.15 μm as described above will be accepted as significant in the art.

### III. Exhaust Removal Performance

THC, CO and NOx conversions upon the particulate filters of Comparative Example 3 and Inventive Example 2 were measured on a 2.0 L turbo charged gasoline engine bench, through lambda scanning from 0.98 to 1.02, with inlet temperature of particulate filter at 695° C. The THC, CO and NOx concentrations were recorded for both upstream and downstream of the filter being tested. The THC, CO and NOx conversions were calculated in accordance with the equation

$$Conversion = ( 1 - \frac{Conc e n {tration}_{( downstream )}}{C o n c e n t r a t i o {n}_{( upstream )}} ) \times 100 \% .$$

The test results are summarized in the Table below.

| | 1^{st} and 2^{nd} | THC | CO | NOx |
|---|---|---|---|---|
| Example | Components | Conv. | Conv. | Conv. |
| Inventive | 95.24% Al₂O₃, | Comparable | Comparable | Comparable |
| Example 2 | 4.76% MnO₂ | | | |
| Comparative | Al₂O₃ | | | |
| Example 3 | | | | |

Conv.: Conversion

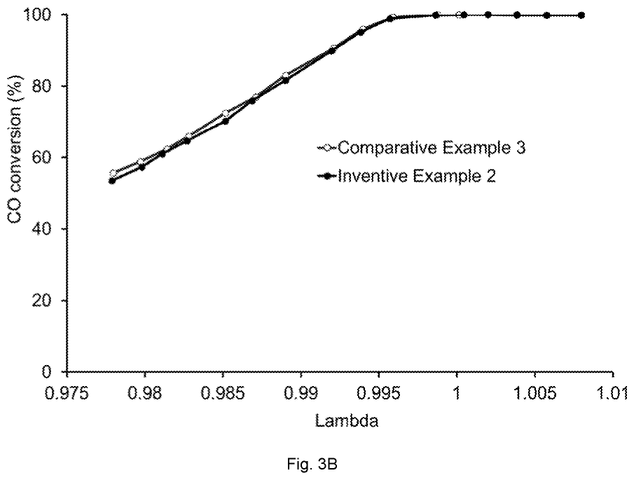

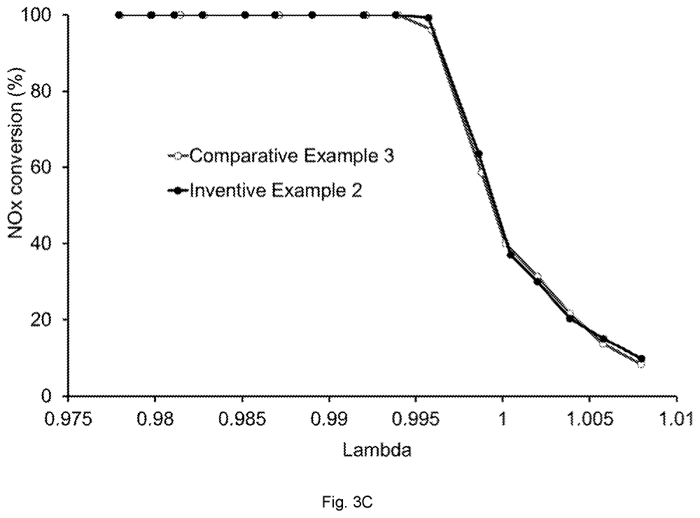

The THC, CO and NOx conversion test results are depicted in FIGS. 3A, 3B and 3C respectively. It has been surprisingly found that the MnO₂ particles present together with Al₂O₃ particles in the same layer did not impose a poisoning effect on the catalytic activity of the particulate filter of Inventive Example 2, as compared to that of Comparative Example 3 containing no MnO₂.

### IV. Filter Regeneration Performance (Soot Burning Activity)

The particulate filters of Comparative Example 4 and Inventive Example 4 were preloaded with about 7 g of soot respectively on a 2.0 L turbo charged gasoline engine, before measurement of soot burning activity.

The soot burning activity of the particulate filters were evaluated on a 2.0 L turbo charged gasoline engine in accordance with the following procedure:
1^{st} Phase: The engine was run at 2000 rpm engine speed under a rich condition such that the temperature was ramped to reach an inlet temperature of the filter at 600° C.; and
2^{nd} Phase: Then, the engine was run at 1000 rpm engine speed under a lean condition with an air/fuel ratio (A) of 1.05 for 75 seconds.

During the procedure, inlet temperature (T-in) and bed temperature (T-bed, located at 1 inch before the outlet end) of the filter were measured, and O₂ concentration for both inlet (O₂-in) and outlet (O₂-out) of the filter were also measured. An increase in the bed temperature (T-bed) indicates exotherm evolution over the filter due to soot burning to CO₂. A decrease in O₂ concentration at outlet of the filter indicates oxygen consumption over the soot layer due to soot burning to CO₂.

The test results are summarized in the Table below.

| | TWC | Layer of Inorganic | 1^{st} and 2^{nd} |
|---|---|---|---|
| Example | Coat | Particles | Components |
| Comparative | no | yes | Al₂O₃ |
| Example 4 | | | |
| Inventive | no | yes | 55.56% Al₂O₃, 44.44% MnO₂ |
| Example 4 | | | |

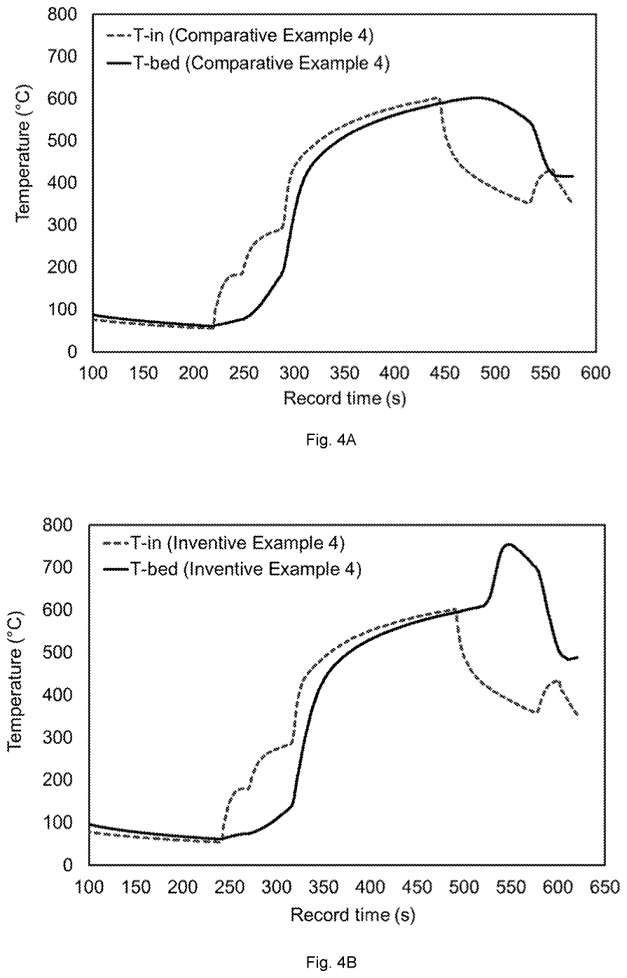

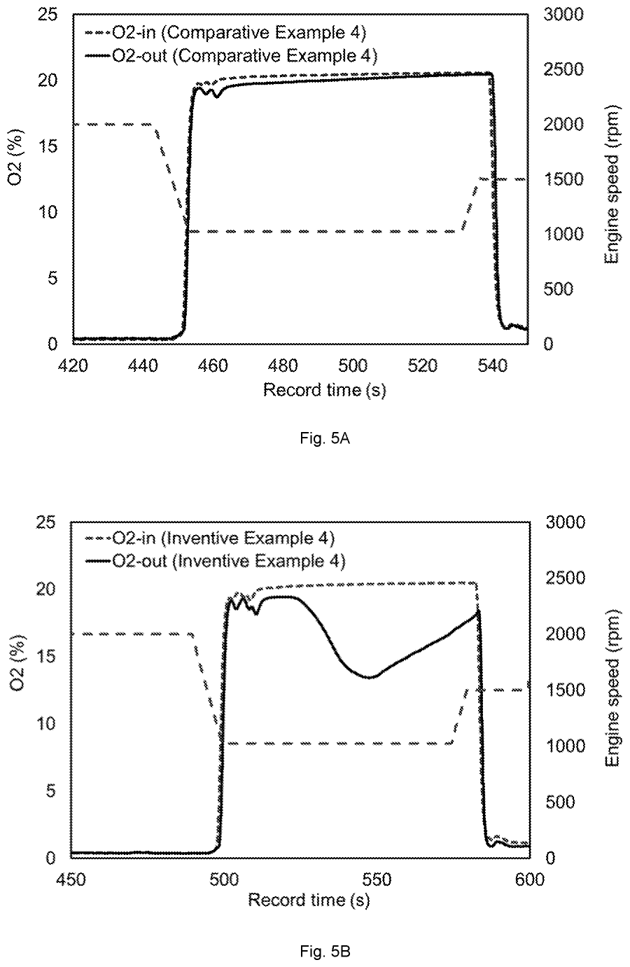

The temperature measurements are depicted in FIGS. 4A and 4B, and the oxygen consumption measurements are depicted in FIGS. 5A and 5B.

A steep rise of temperature which is attributed to soot burning was observed for the particulate filter of Inventive Example 4 while the inlet temperature (T-in) drops as shown in FIG. 4A. No appreciable rise of bed temperature (T-bed) above 600° C. was observed for the particulate filter of Comparative Example 4, as shown in FIG. 4B.

An obvious O₂ consumption over particulate filter during the 2^{nd} Phase under lean condition (λ=1.05) at 1000 rpm) was observed for the particulate filter of Inventive Example 4, which is attributed to soot burning, as shown in FIG. 5A. However, no O₂ consumption was observed for the particulate filter of Comparative Example 4, as shown in FIG. 5B.

It can be seen, regeneration of the particulate filter with a layer of inorganic particles containing Al₂O₃ particles and MnO₂ particles according to the present invention can be started at a much lower temperature. It was proved that the soot burning activity of the filter can be improved by addition of MnO₂ in the layer comprising Al₂O₃ particles.

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels of the substrate, preferably in at least the inlet channels,
wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

2. The particulate filter according to claim 1, wherein the first inorganic component is one or more selected from alumina, zirconia, ceria, silica, titania, zinc oxide and rare earth metal oxide other than ceria.

3. The particulate filter according to claim 2, wherein the first inorganic component is one or more selected from alumina, zirconia and zinc oxide.

4. The particulate filter according to claim 3, wherein the first inorganic component comprises or is alumina.

5. The particulate filter according to claim 1, wherein the layer of inorganic particles exhibits no three-way conversion catalytic activity.

6. The particulate filter according to claim 1, wherein the layer of inorganic particles does not comprise a PGM component.

7. The particulate filter according to claim 1, which further comprises a three-way conversion catalyst (TWC) coat, preferably a washcoat comprising a TWC composition.

8. The particulate filter according to claim 7, wherein the three-way conversion catalyst coat is in at least a portion of the inlet channels and/or outlet channels of the substrate.

9. The particulate filter according to claim 1, which comprises the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).

10. The particulate filter according to claim 1, which is a gasoline particulate filter.

11. The particulate filter according to claim 1, wherein the inorganic particles comprise the second inorganic component in an amount of 3 to 70% or 3 to 50%, based on the total weight of the inorganic particles.

12. The particulate filter according to claim 11, wherein the inorganic particles comprise the second inorganic component in an amount of 3 to 15%, 4 to 12% or 4 to 10%, based on the total weight of the inorganic particles.

13. The particulate filter according to claim 11, wherein the inorganic particles comprise the second inorganic component in an amount of 40 to 70%, 40 to 50% or 42 to 46%, based on the total weight of the inorganic particles.

14. A method for producing a particulate filter as defined in claim 1, which includes:
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
applying inorganic particles on surfaces of the porous walls in the inlet channels and/or outlet channels of the substrate, wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combinations thereof, and a manganese oxide as a second inorganic component.

15. The method according to claim 14, wherein the inorganic particles are applied by a dry coating process or washcoating process, preferably by a dry coating process.

16. The method according to claim 15, wherein the inorganic particles are applied by using the inorganic particles or precursors thereof.

17. An exhaust treatment system, which comprises a particulate filter which comprises:
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels of the substrate, preferably in at least the inlet channels,
wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combination thereof, and a manganese oxide as a second inorganic component,
or a particulate filter obtainable or obtained from the method according to claim 14, and is located downstream of a gasoline engine.

18. A method for treating an exhaust stream from a gasoline engine, which includes contacting the exhaust stream with a particulate filter which comprises:
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels of the substrate, preferably in at least the inlet channels,
wherein the inorganic particles comprise a first inorganic component selected from alumina, zirconia, ceria, silica, titania, zinc oxide, zinc carbonate, calcium oxide, calcium carbonate, silicate zeolite, aluminosilicate zeolite or any combination thereof, and a manganese oxide as a second inorganic component,
or an exhaust treatment system as defined in claim 17.
